(19) United States
(12) Patent Application Publication
(10) Pub. No.: US 2005/0271201 A1
(43) Pub. Date: Dec. 8, 2005

(54) Encryption circuit

(75) Inventors: Kazuya Shimizu, Takatsuki-shi (JP); Tomoya Sato, Yamatotakada-shi (JP); Kentaro Shiomi, Nagaokakyo-shi (JP); Yusuke Nemoto, Kobe-shi (JP); Yuishi Torisaki, Takarazuka-shi (JP); Makoto Fujiwara, Kyoto-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/133,289

(22) Filed: May 20, 2005

(30) Foreign Application Priority Data
May 24, 2004 (JP) 2004-152852

(51) Int. Cl. H04K 1/00

(52) U.S. Cl. 380/28

(57) ABSTRACT

An encryption circuit of a secret key cryptosystem which inputs a plain text and a secret key 4A, inputs R partial keys Kn obtained from the secret key 4A and applies repeatedly R times of round operations to the plain text so that the plain text is encrypted including: registers 4G and 4H which store the values after the round operations of the plain text; a fault detection circuit 1A which decides whether a degenerate fault exists or not by the values of the registers 4G and 4H; and a circuit 1B which invalidates the secret key 4A when the degenerate fault exists in the detection result. The invention provides an encryption circuit which can appropriately respond to a new element of causing occurrence of the degenerate fault, suppress the cost of the hardware, and has a measure against the fault analysis while suppressing an increase in an encryption processing time.

### BACKGROUND OF THE INVENTION

1. Field of the Invention

The present invention relates to a circuit which is installed inside of a card such as an IC card or a media card or inside of an information processing terminal and the like (which will be referred to as a confidential information processing apparatus henceforth) and which works to protect confidential information that is recorded in the confidential information processing apparatus, and in particular, relates to an encryption circuit which includes a countermeasure against a fault analysis attack which has recently become a security threat.

2. Description of the Prior Art

Recently, confidential information processing apparatuses have become widely used in financial and circulation markets which use credit cards or electronic money and the like, and have become playing an important role in supporting an information society. However, when the confidential information processing apparatus is used, it becomes indispensable that the confidential information recorded in the confidential information processing apparatus should never be leaked outside by an attacker having a malicious intention.

However, some methods of illegally acquiring the confidential information in such a confidential information processing apparatus have been already reported, and they are called the probe analysis, the power analysis, and the timing analysis. Therefore, it has been an indispensable subject to establish countermeasures against above-mentioned analysis technologies, when considering usage of the confidential information processing apparatus.

Among these analysis technologies, especially, an analysis technology which is referred to as the fault analysis has become an issue, in which a physical fault is intentionally generated in an encryption circuit which performs encryption processes and which is installed in the confidential information processing apparatus, and by using difference between a value on a signal line in the encryption circuit when a fault is not generated on the signal line and a value on the signal line in the encryption circuit when the fault is generated on the signal line, a secret key which is confidential information installed in the confidential information processing apparatus is presumed (refer to “Investigation Report for the Heisei 11 Fiscal Year on Security of the Smart Card”, [online], [searched on October 27, Heisei 15], The Internet URL: http://www.ipa.go.jp/security/fy11/report/contents/crypto/crypto/report/SmartCard/sc.html).

There are two kinds of attack methods in the fault analysis; the non-differential fault analysis and the differential fault analysis. In the non-differential fault analysis, when a stuck-at 0 fault (or stuck-at 1 fault) in which a signal value becomes always zero (or one in case of stuck-at 1 fault) is intentionally generated in a flip-flop of registers used for storing a processed value of an encryption process in the encryption circuit which realizes the encryption processes, then the secret key can be decrypted by using the circuit values when the fault is not generated and when the fault is generated. On the other hand, in the differential fault analysis, instead of the fault at which the circuit value becomes always zero or one, the fault in which the circuit value is temporarily fixed to zero or one is generated in the circuit, and the analysis is carried out by furthermore generating the fault in the flip-flop in the registers of the encryption circuit, or in a combination circuit which performs operation necessary for performing encryption processes.

In the differential fault analysis, however, it is necessary for the attacker at the attack to generate a temporary degenerate fault in the flip-flop or in the combination circuit of the encryption circuit only during a period that the attacker intended. In addition, for any fault analysis, in order to acquire secret key information, it is generally necessary to perform the encryption processes for about 50 to 200 data.

As a conventional countermeasure against a fault analysis, there is a method in which a circuit for detecting heat or a voltage which causes a fault occurrence is equipped within a chip including the encryption circuit and the secret key information of the confidential information processing apparatus. In this method, when a cause of a fault occurrence such as heat or the voltage is applied to the chip containing the encryption circuit and the secret key information, the cause of such a fault occurrence is detected by the detection circuit, and operation of the circuit in the chip is stopped, or the use of the chip is prohibited.

There are two methods which do not employ a detection circuit; one is to perform the same two encryption processes in the encryption circuit as shown in FIG. 20, and the other is to perform a decryption process in addition to the encryption process as shown in FIG. 21 (refer to JP,10-154976,A). In the method in FIG. 20, an encryption process 20C and an encryption process 20D which perform the same processes are applied to a plain text 20A which is an object of the encryption processes, and by using a secret key 20B for generating a cipher text from the plain text, cipher texts 20E and 20F which are outputs of the two encryption processes are obtained. Then, the two cipher texts are compared by a comparison function 20G. When a comparison result 20H shows a difference, since it becomes apparent that one of the two cipher texts has a different value, because of an influence of the fault, from the value when there is no fault, a decision that a fault exists in either of the encryption circuits which realize the encryption process 20C and the encryption process 20D is made. In the method in FIG. 21, an encryption process 21C is applied to a plain text 21A which is an object of the encryption process by using a secret key 21B for generating a cipher text from the plain text, so that a cipher text 21D is obtained. Then the secret key 21B is applied again to the cipher text 21D for a decryption process 21E, and a plain text 21F is obtained. The plain text 21F is then compared by a comparison function 21G with the plain text 21A before the encryption process, and when a comparison result 21H shows a difference, since it becomes apparent that either the encryption process 21C or the decryption process 21E is not correctly performed because of the influence of the fault, a decision that a fault exists in either one of the two encryption circuits which realize those processes is made.

However, in case when the circuit which detects heat or the voltage applied to generate the degenerate fault is used, a problem arises that when a new element of causing occurrence of a fault other than the voltage or heat is used, such an element cannot be detected.

Further, in the invention of JP,10-154976,A, a problem exists in that since the same secret key is applied to the same plain text for encryption as shown in FIG. 20 in order to check whether the same cipher texts are outputted or not, two encryption circuits are required for the purpose, which leads to an increase in the hardware cost and to inability to appropriately respond when degenerate faults are generated in the same portion of the two encryption circuits.

In the above-mentioned invention of JP,10-154976,A, although another method may exist in which the encrypted cipher text is decrypted by applying the same secret key again as shown in FIG. 21 and whether the same plain text as the original is generated or not is checked, since the decryption process must be applied to the same plain text in addition to the encryption process, a problem arises that time required for the encryption process increases.

### SUMMARY OF THE INVENTION

The purpose of the present invention is to provide an encryption circuit which can detect a fault without being dependent on the cause of an fault occurrence, can realize suppression of a hardware increase as compared with the case where the same two encryption circuits are used, and can realize suppression of an increase in the processing time required for a fault detection.

In order to attain the purpose, in the present invention, a fault detection circuit which decides whether the fault exists or not by using values of the signal lines of the encryption circuit is equipped within the encryption circuit, and thereby the fault can be detected without being dependent on the cause of the fault occurrence. Additionally, the fault detection circuit is realized suppressing the increase in the hardware volume as compared with a case where the same two encryption circuits are used, or suppressing the increase in the processing time required for the fault detection.

In order to solve the above-mentioned problems, in the present invention, a detection circuit which detects a fault by using values of registers used for storing values at encryption processing stages in an encryption circuit is equipped in the encryption circuit. As the values stored in the registers, the values after each round operation are used; here, in a secret key encryption algorithm in which a plain text is encrypted by using a secret key for encrypting or decrypting the plain text, round operations are repeatedly applied R times to the plain text for the purpose of encrypting the plain text, by using R partial keys as inputs which are obtained by applying R times of partial key operation to the secret key. Since the fault detection circuit equipped in the encryption circuit detects the fault by using the values of the registers which store the values after round operation, fault detection becomes possible by which the increase in the hardware cost is suppressed as compared with the case where two encryption circuits are used and their outputs are compared, or the fault detection becomes possible by which the increase in an encryption processing time is suppressed as compared with the case where the decryption process is performed in addition to the encryption process. According to a detection result outputted from the fault detection circuit, when it becomes clear that the fault exists, information that the fault exists is informed to a circuit which invalidates the secret key so that the secret key is invalidated, or information that the fault exists is informed to a circuit which controls operation of the encryption circuit so that leakage of secret key information can be prevented by stopping processing of the encryption circuit.

The encryption circuit of the present invention is an encryption circuit of a secret key cryptosystem which inputs an object of encryption and a secret key, obtains R partial keys by applying R times of partial key operations to the secret key, and inputs the R partial keys for applying R times of round operations to the object of encryption so that the object of encryption is encrypted including:

registers which store values after the round operations for the object of encryption; a fault detection circuit which decides whether a degenerate fault exists or not by the values of the registers; and a circuit which inputs the detection result of the fault detection circuit and invalidates the secret key when the degenerate fault exists in the detection result.

For example, the encryption circuit includes: the register that holds the secret key; the fault detection circuit which uses the value of the register that stores the value after the round operation, and decides during a decision processing period for deciding whether a stuck-at 0 fault or a stuck-at 1 fault exists or not in the register that stores the value after round operations; and a circuit which invalidates the value of the register that holds the secret key, when it is confirmed that a degenerate fault exists in the register that stores the value after the round operations by the detection result outputted from the fault detection circuit.

Another encryption circuit of the present invention is an encryption circuit of a secret key cryptosystem which inputs an object of encryption and a secret key, obtains R partial keys by applying R times of partial key operations to the secret key, and inputs the R partial keys for applying R times of round operations to the object of encryption so that the object of encryption is encrypted including:

registers which store values after the round operations for the object of encryption; a fault detection circuit which decides whether a degenerate fault exists or not by the values of the registers; and a circuit which inputs the detection result of the fault detection circuit and which stops operation of the encryption circuit by a circuit which controls operation of the encryption circuit, when a degenerate fault exists in the detection result.

For example, the encryption circuit includes: the register that holds the secret key; the fault detection circuit which uses the value of the register that stores the value after the round operations, and decides during a decision processing period for deciding whether a stuck-at 0 fault or a stuck-at 1 fault exists or not in the register that stores the value after round operations; and a circuit which stops processing of the encryption circuit, when it is confirmed that a degenerate fault exists in the register that stores the value after round operations by the detection result outputted from the fault detection circuit.

In the above-mentioned configuration, the fault detection circuit decides existence or nonexistence of the degenerate fault in the register, from values before and after storing in the register that stores the value after round operations. For example, the fault detection circuit is composed so that it can decide whether the stuck-at 0 fault or the stuck-at 1 fault exists or not in the register that stores the value after the round operations, by using the both values before and after storing in the register that stores the value after round operations, and by setting the decision processing period for deciding whether the fault exists or not as parallel with the round operations.

In the above-mentioned configuration, the fault detection circuit decides whether the fault exists or not by the values of the registers after finishing the round operations performed for a verification pattern which is prepared beforehand. For example, by using the verification pattern prepared beforehand for the purpose of deciding whether the fault exists or not, the fault detection circuit is composed so that it can decide, in the decision processing period for deciding whether the fault exists or not, the existence or nonexistence of the zero or the stuck-at 1 fault in a combination circuit which performs the round operations to the data, in addition to the zero or the stuck-at 1 fault in the register that stores the value after the round operations.

In the above-mentioned configuration, the fault detection circuit decides whether the fault exists or not for the encryption processes for all the data. For example, the decision processing period is set for deciding whether the fault exists or not during the encryption processes for all the data, and when it becomes clear that the degenerate fault exists by the detection result of the fault detection performed within the period, the secret key is invalidated or the processing of the encryption circuit is stopped to prevent the fault analysis.

In the above-mentioned configuration, during encryption processes for consecutive N data, the fault detection circuit decides whether the fault exists or not for M data (M<N). For example, a prescribed number N is set beforehand, and the decision processing period is set for deciding whether the fault exists or not during the encryption processes for M data among consecutive N data (M<N), and when it becomes clear that the degenerate fault exists by the detection result of the fault detection performed within the period, the secret key is invalidated or the processing of the encryption circuit is stopped to prevent the fault analysis.

In the above-mentioned configuration, the fault detection circuit decides whether the fault exists or not before starting R times of the round operations and after finishing R times of the round operations. For example, for each data to which the fault detection is applied, the decision processing period is set for deciding whether the fault exists or not before starting and after finishing R times of the round operations specified by an encryption processing standard, and when it becomes clear that the degenerate fault exists by the detection result of the fault detection performed within the period, the secret key is invalidated or the processing of the encryption circuit is stopped to prevent the fault analysis.

In the above-mentioned configuration, the fault detection circuit decides whether the fault exists or not for all R times of the round operations. For example, for each data to which the fault detection is applied, the decision processing period is set for deciding whether the fault exists or not for all the R times of the round operations specified by the encryption processing standard, and when it becomes clear that the degenerate fault exists by the detection result of the fault detection performed within the period, the secret key is invalidated or the processing of the encryption circuit is stopped to prevent the fault analysis.

In the above-mentioned configuration, the fault detection circuit decides whether the fault exists or not for N times of the round operations among R times (N<R) of the round operations. For example, for each data to which the fault detection is applied, a prescribed number N (N<R) is set under the encryption processing having a standard round number R, the decision processing period is set for deciding whether the fault exists or not for N times of the round operations among R times of the round operations, and when it becomes clear that the degenerate fault exists by the detection result of the fault detection performed within the period, the secret key is invalidated or the processing of the encryption circuit is stopped to prevent the fault analysis.

In the above-mentioned configuration, the fault detection circuit performs the round operation for the verification pattern for R−n times of the round operations which number is n times fewer than the R times of the round operation number specified by the encryption processing standard, and whether the fault exists or not is decided by an obtained value. For example, for each data to which the fault detection is applied, in the decision processing period for deciding whether the fault exists or not, the fault detection circuit performs the round operations for the verification pattern that is used for deciding whether the fault exists or not for R−n times of the round operations which number is n times fewer than the R times of the round operation number specified by the encryption processing standard, and when it becomes clear that the degenerate fault exists, the secret key is invalidated or the processing of the encryption circuit is stopped to prevent the fault analysis.

In the above-mentioned configuration, the fault detection circuit performs the round operations for the verification pattern for R+n times of the round operations which number is n times larger than the R times of the round operation number specified by the encryption processing standard, and whether the fault exists or not is decided by the obtained value. For example, for each data to which the fault detection is applied, in the decision processing period for deciding whether the fault exists or not, the fault detection circuit performs the round operations for the verification pattern that is used for whether the fault exists or not for R+n times of the round operations which number is n times larger than the R times of the round operation number specified by the encryption processing standard, and when it becomes clear that the degenerate fault exists, the secret key is invalidated or the processing of the encryption circuit is stopped to prevent the fault analysis.

According to the above-mentioned encryption circuit of the present invention, the detection circuit that detects the degenerate fault by using the values of the registers that store values after the round operations is equipped within the encryption circuit, and by invalidating the secret key information or by stopping the processing of the encryption circuit according to the detection result of the detection circuit, an appropriate response can be available even when a new element of causing occurrence of the fault other than a voltage or heat is used, and also a countermeasure against the fault analysis becomes possible while suppressing the increase in the hardware, or while suppressing the increase in the processing time by deciding whether the fault exists or not in parallel with the encryption processing.

### BRIEF DESCRIPTION OF THE DRAWINGS

FIG. 1 is a block diagram showing an outline of an encryption circuit in a first embodiment of the present invention having functions of a fault detection and a secret key invalidation;

FIG. 2 is a diagram showing the encryption circuit which is equipped with an algorithm of a secret key cryptosystem which is the subject of the present invention;

FIG. 3 is a diagram showing contents of a DES algorithm;

FIG. 4 is a block diagram showing the contents of a circuit which performs round operations in the DES algorithm without sharing registers;

FIG. 5 is a block diagram showing the contents of the circuit which performs the round operations in the DES algorithm sharing registers;

FIG. 6 is a block diagram showing the contents of the encryption circuit having the functions of the fault detection and the secret key invalidation by setting one to the all bits of registers;

FIG. 7 is a block diagram showing the contents of the encryption circuit having the functions of the fault detection and the secret key invalidation by serially outputting a value of the register;

FIG. 8 is a block diagram showing the contents of a secret key invalidation circuit in a second embodiment of the present invention;

FIG. 9 is a block diagram showing the contents of the encryption circuit in a third embodiment of the present invention having the functions of the fault detection and the secret key invalidation;

FIG. 10 is a block diagram showing the contents of the encryption circuit in a fourth embodiment of the present invention having the functions of the fault detection and the secret key invalidation by using a verification pattern and an expected value;

FIG. 11 is a block diagram showing the contents of the encryption circuit having functions of the fault detection and the secret key invalidation by using the verification pattern which sets all of the register bit values to one;

FIG. 12 is a block diagram showing the contents of the encryption circuit having the functions of the fault detection and the secret key invalidation by using the verification pattern which sets values of two registers to an equal value;

FIG. 13 is an explanatory diagram showing a performing period of the fault detection of the encryption circuit 2A in a fifth embodiment of the present invention;

FIG. 14 is an explanatory diagram showing the performing period of the fault detection of the encryption circuit 2A in a sixth embodiment of the present invention;

FIG. 15 is an explanatory diagram showing the performing period of the fault detection of the encryption circuit 2A in a seventh embodiment of the present invention;

FIG. 16 is an explanatory diagram showing the performing period of the fault detection of the encryption circuit 2A in an eighth embodiment of the present invention;

FIG. 17 is an explanatory diagram showing the performing period of the fault detection of the encryption circuit 2A in a ninth embodiment of the present invention;

FIG. 18 is an explanatory diagram showing the performing period of the fault detection of the encryption circuit 2A in a tenth embodiment of the present invention;

FIG. 19 is an explanatory diagram showing the performing period of the fault detection of the encryption circuit 2A in an eleventh embodiment of the present invention;

FIG. 20 is an explanatory diagram showing the outline of a conventional method using two encryption circuits;

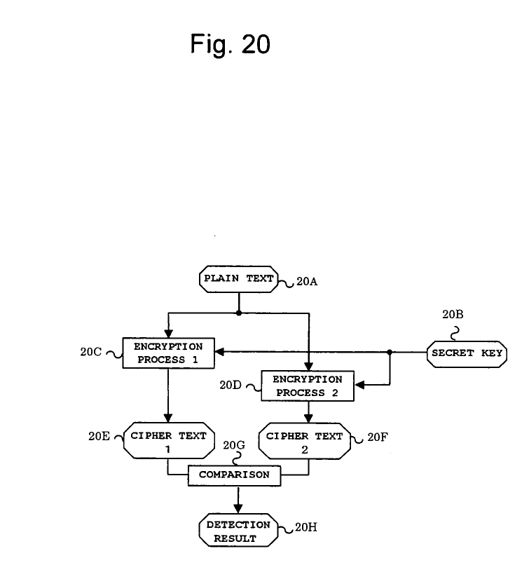

FIG. 21 is an explanatory diagram showing the outline of a conventional method using the encryption circuit and a decryption circuit.

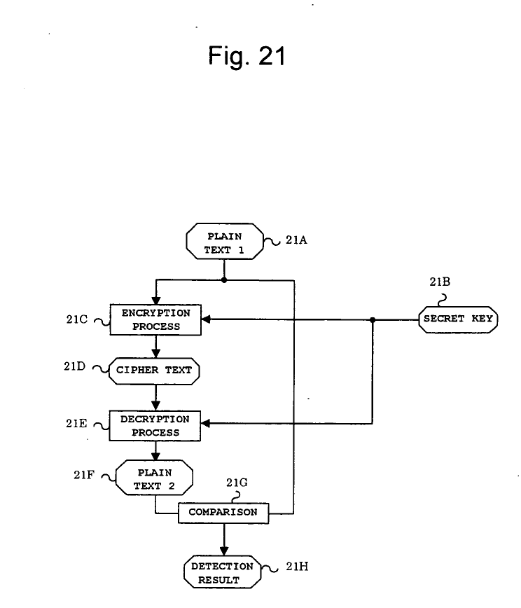

### DESCRIPTION OF PREFERRED EMBODIMENTS

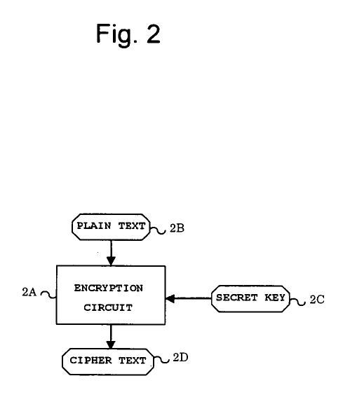

FIG. 2 is a diagram showing an algorithm of a secret key cryptosystem that is a subject of the present invention. In FIG. 2, an encryption circuit 2A inputs a plain text 2B which is an object of encryption and a secret key 2C which is a key for encrypting the plain text 2B, performs predetermined operations that are specified by an encryption algorithm, and outputs a cipher text 2D.

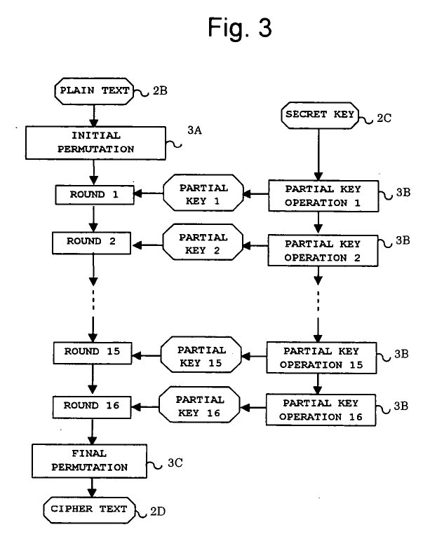

FIG. 3 illustrates an algorithm called DES (Data Encryption Standard), as an example of the algorithm of the secret key cryptosystem realized by the encryption circuit 2A. In FIG. 3, the same numerals are used to show the same components as in FIG. 2, and descriptions for them are omitted. In the DES algorithm for the secret key cryptosystem, after performing an initial permutation 3A to the plain text 2B, data is divided into upper 32 bits and lower 32 bits, and 16 stages of round operations are repeated for each of the divided data. At each round operation, a partial key generated by a partial key operation 3B applied to the secret key 2C is used. A partial key n generated by a partial key operation n will be expressed as Kn henceforth. After finishing the 16 stages of the round operations, a final permutation 3C is performed to obtain the cipher text 2D.

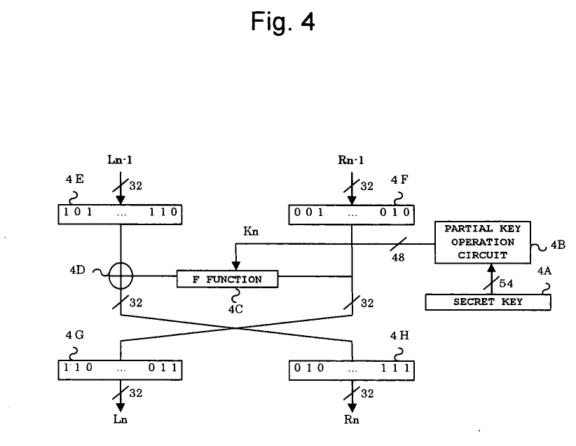

FIG. 4 illustrates a circuit which performs the round operations in the DES algorithm, and by applying the partial key Kn that is generated from a secret key 4A by using a partial key operation circuit 4B to this circuit, data Ln−1 and Rn−1 after the (n−1)th round operation and data Ln and Rn after the n-th round operation can be obtained. In the DES algorithm, Ln and Rn are given by the following formulas using a function called the F function to which inputs are Rn−1 and Kn; Ln=Rn−1, Rn=Ln−1 XOR F(Rn−1, Kn).

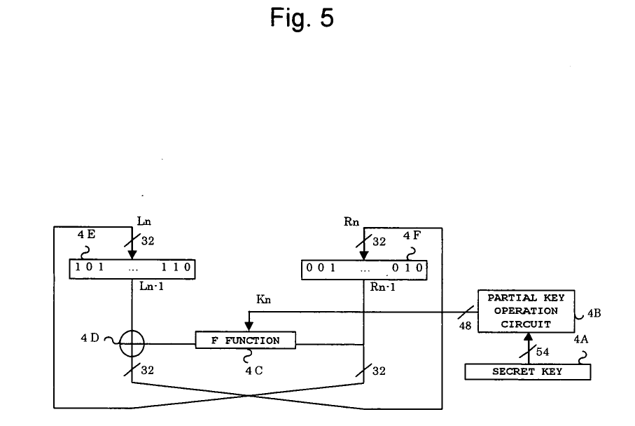

Here, F(Rn−1, Kn), which is the F function, is composed as an F function 4C in FIG. 4, and XOR (the exclusive-or function) is composed by an XOR 4D in the figure. The data Ln−1 and Rn−1 after the (n−1)th round operation are stored in registers 4E and 4F, respectively, and the data Ln and Rn after the n-th round operation are stored in registers 4G and 4H, respectively. However, as shown in FIG. 5, the registers 4E and 4F which respectively store the data Ln−1 and Rn−1 after the (n−1)th round operation can be commonly used as the registers which store the data Ln and Rn after the n-th round operation. Since the DES algorithm is an open and well-known algorithm, description for details of the F function 4C, the initial permutation 3A, the partial key operation 3B, and the final permutation 3C are omitted.

In the following embodiments of the present invention, the encryption circuit 2A is installed with an improved DES algorithm so that it can have a countermeasure against a fault analysis.

### Embodiment 1

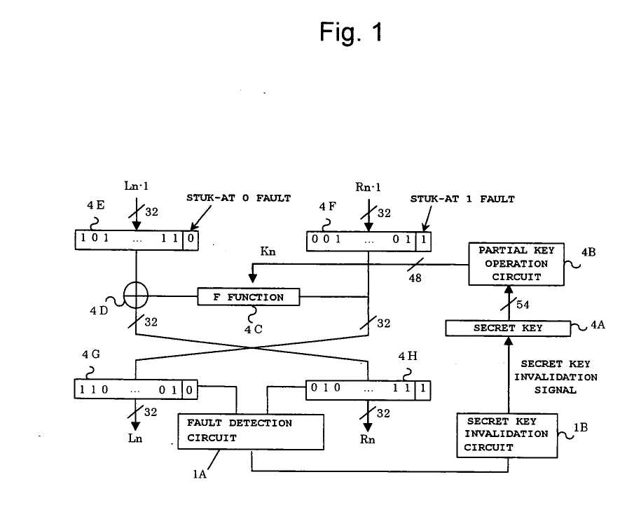

FIG. 1 is a block diagram showing the outline of the round operations in a first embodiment of the present invention having functions of a fault detection and a secret key invalidation. In FIG. 1, the same numerals are used to show the same components as in FIGS. 2, 3, and 4, and descriptions for them are omitted. The circuit of FIG. 1 includes, in addition to the circuit shown in FIG. 4 that realizes the round operations of the DES algorithm, a fault detection circuit 1A that is inputted with the values of the registers 4G and 4H in which values after the round operations during a decision processing period for deciding whether a fault exists or not and that decides whether a degenerate fault exists or not by the values of the registers, and an additional secret key invalidation circuit 1B that invalidates the secret key 4A in the encryption circuit by using a secret key invalidation signal when it becomes clear according to a decision result outputted from the fault detection circuit 1A that the degenerate fault exists in a flip-flop that constitutes the registers 4G and 4H. In FIG. 1, the degenerate fault in the registers 4G and 4H which respectively store the data Ln and Rn after the n-th round operation is to be detected, and in this case, the values of the registers 4G and 4H are outputted to the inputs of the fault detection circuit 1A. When it becomes clear that the degenerate fault exists in the registers 4G and 4H, the secret key 4A is invalidated. An example of the invalidation method is to reset the value of the register that stores the secret key 4A. When detecting the degenerate fault that exists in a register other than the registers 4G and 4H, the encryption circuit can be configured so that values of the other registers are inputted to the fault detection circuit 1A for performing the fault detection by using values of the other registers. Further, as shown in FIG. 5, in case when the registers 4E and 4F which respectively store the data Ln−1 and Rn−1 after the (n−1)th round operation are commonly used as the registers which store the data Ln and Rn after the n-th round operation, the encryption circuit can also be configured similarly so that the fault detection is performed by using the values of registers 4E and 4F which are commonly used for invalidating the secret key 4A.

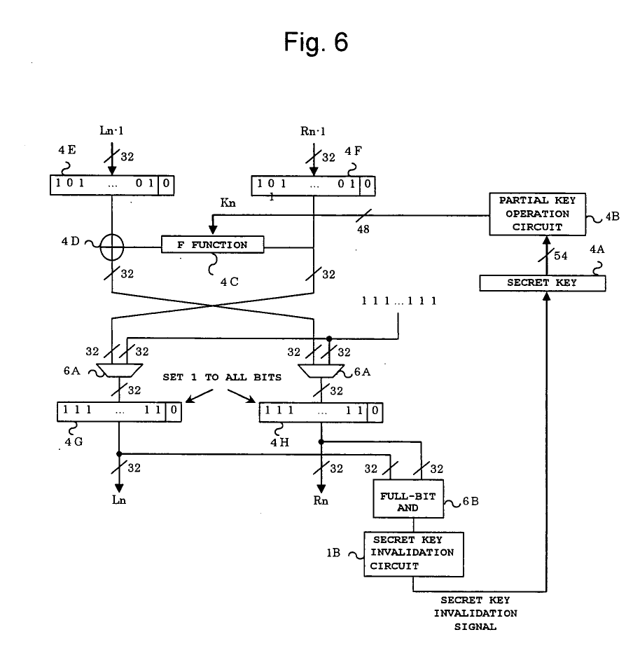

The circuit that performs the round operations in FIG. 1 can be configured as shown in FIG. 6. In this circuit, selectors 6A can be inserted at the input to the registers 4G and 4H, so that a selection can be made whether the values Ln and Rn after round operations be stored in the registers 4G and 4H, or a verification pattern be set. The outputs of registers 4G and 4H are connected to a full-bit AND 6B, and the output of the full-bit AND 6B is connected to the secret key invalidation circuit 1B. In this circuit, in case when a stuck-at 0 fault which is a fault where the values of registers 4G and 4H are fixed to zero is to be detected, during the decision processing period for deciding whether a fault exists or not, the selectors 6A are used to set zeros to all bits of the registers 4G and 4H. In a setting as this, when no stuck-at 0 faults exist in the registers 4G and 4H, the output of the full-bit AND 6B becomes one, and when a stuck-at 0 fault exists in one of the flip-flops, the output becomes zero according to the value of the flip-flop. Accordingly, the secret key invalidation circuit 1B the input of which is connected to the output of the full-bit AND 6B can invalidate the secret key according to this input when the degenerate fault exists. When a stuck-at 1 fault which is a fault where the values of registers 4G and 4H are fixed to one is detected, the selectors 6A are used to set zeros to all bits of the registers 4G and 4H, and a full-bit OR can be used in place of the full-bit AND 6B. In this case, when no stuck-at 1 faults exist in the registers 4G and 4H, the output of the full-bit OR becomes zero, and when a stuck-at 1 fault exists in one of the bits, the output becomes one according to the value of the bit. Therefore, by using this output, the secret key can be invalidated similar to the case of the stuck-at 0 fault. Further, when detecting a degenerate fault that exists in a register other than the registers 4G and 4H which store Ln and Rn, respectively, by installing selectors similar to the selectors 6A at the inputs of the registers, enabling to set one or zero to all the bits of these registers, and connecting the values of the registers to the full-bit AND or to the full-bit OR, it becomes possible to detect the degenerate fault and to invalidate the secret key.

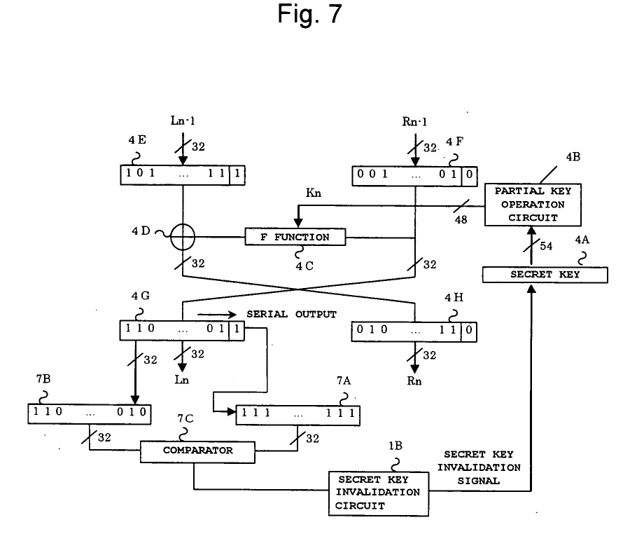

The circuit in FIG. 1 that performs the round operations can also detect a fault, as shown in FIG. 7, by using a register 7A which accepts a serial output from the register 4G by shifting operation, a register 7B which can copy the value of the register 4G, and a comparator 7C. When the degenerate fault exists in the register 4G that stores Ln, in case, for example, of the stuck-at 1 fault, all the bits of the serial output data from the register 4G after a certain bit become fixed to one. Since the values of the register 7A and the register 7B are different from each other in this case, the fault can be detected by comparing these values by using the comparator 7C. When the stuck-at 0 fault exists in the register 4G, the fault can also be detected similarly. In case when other registers than the register 4G are to be checked for the fault detection, the fault can be detected similarly by using a register to which the value is serially outputted and a resister which copies the value.

As aforementioned, by using the values of the registers that store the values after the round operations, an appropriate response can be available even when a new element of causing occurrence of the fault other than a voltage or heat is used. Additionally, the fault detection becomes possible by which a hardware volume is suppressed as compared with the case where two encryption circuits are used.

### Embodiment 2

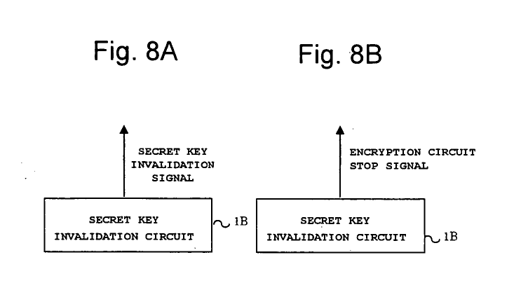

FIG. 8 is a block diagram showing the configuration of the secret key invalidation circuit in a second embodiment of the present invention. Whereas the secret key invalidation circuit 1B that is used in the encryption circuit of the first embodiment is configured as shown in FIGS. 1, 6, and 7 so that it outputs the secret key invalidation signal in order to invalidate the secret key 4A, in the encryption circuit of the second embodiment, instead of outputting the secret key invalidation signal as shown in FIG. 8A, the secret key invalidation circuit 1B outputs an encryption circuit stop signal as shown in FIG. 8B in order to inform a circuit that controls operation of the encryption circuit that a fault exists, enabling the encryption circuit to stop operation.

### Embodiment 3

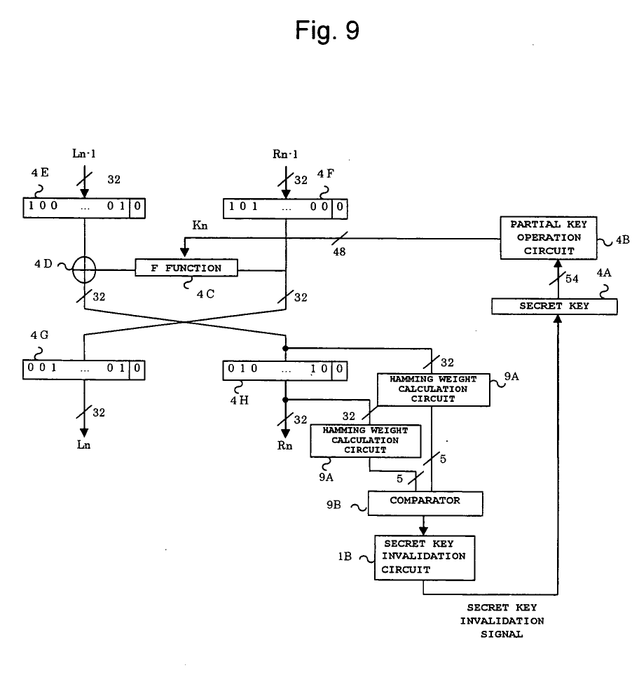

FIG. 9 is a block diagram showing contents of the round operations in a third embodiment of the present invention having the functions of the fault detection and the secret key invalidation. In FIG. 9, the same numerals are used to show the same components as in FIGS. 1, 2, 3, and 4, and descriptions for them are omitted. In this circuit, two Hamming weight calculation circuits 9A which compute the Hamming weight are used, and the value of Rn before setting to the register 4H and the value of Rn after setting to the register 4H are inputted respectively to each of the circuits 9A. Here, the Hamming weight is defined as a number of bits which take the value one as a numeral expressed by binary digits. A comparator 9B compares the outputs of the two Hamming weight calculation circuits 9A, and the output of the comparator is inputted to the secret key invalidation circuit 1B to invalidate the secret key 4A. In this circuit, the fault detection is performed for the degenerate fault which exists in the register 4H that stores the data Rn after the n-th round operation.

When this circuit configuration is used, in case when the stuck-at 0 fault or the stuck-at 1 fault exists in any bit of the register 4H, by the influence of the fault, the Hamming weight for the value to be set in the register after setting to the register 4H may change from the value before setting. For example, when there exists a bit at which the stuck-at 0 fault is occurring, and the value one is forced to be set further to this bit, the Hamming weight after the setting to the register 4H is reduced by one from the Hamming weight before setting because of the influence of the stuck-at 0 fault at this bit. Accordingly, by comparing the Hamming weight before and after setting Rn to the register 4H by using the comparator 9B, existence of the degenerate fault can be decided. However, when there exists a bit at which the stuck-at 0 fault is occurring, and the value zero is forced to be set further to this bit, since the Hamming weight before and after setting to the register 4H does not change, the fault will be overlooked. Although the probability of overlooking in this case is ½, since operations for 50 to 200 data are required for performing the fault analysis, it is supposed that the probability of overlooking the fault in all of these data is low.

When the above-mentioned configuration is used, since the Hamming weight before setting to the register 4H and the Hamming weight after setting can be calculated without interrupting the round operations, the fault detection during performing the round operations becomes possible. Similarly, when detecting the degenerate fault that exists in a register other than the register 4H, the encryption circuit can be configured so that the Hamming weight is calculated before and after setting to the register.

In the circuit in FIG. 9, instead of outputting the secret key invalidation signal from the secret key invalidation circuit 1B for invalidating secret key 4A, the encryption circuit stop signal may be outputted from the secret key invalidation circuit 1B, allowing information that the fault exists to be informed to the circuit that controls the operation of the encryption circuit when the fault exists, so that leakage of the secret key information can be prevented by stopping the processing of the encryption circuit.

As described above, as for the registers that store the values after the round operations by using the value before setting to the register in addition to the value after setting to the register, the detection of the degenerate fault during performing the round operations becomes possible, so that the countermeasure against the fault analysis becomes possible while suppressing an increase in the encryption processing time.

### Embodiment 4

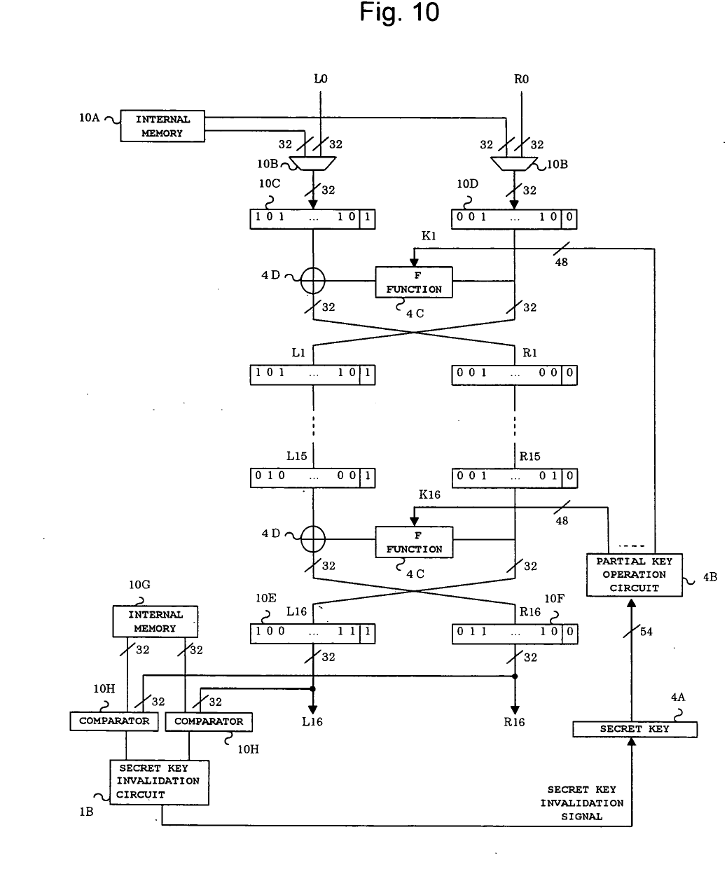

FIG. 10 is a block diagram showing the contents of the round operations in a fourth embodiment of the present invention having the functions of the fault detection and the secret key invalidation. In FIG. 10, the same numerals are used to show the same components as in FIGS. 1, 2, 3, and 4, and descriptions for them are omitted. In this circuit, selectors 10B are provided which select whether data before starting the round operation be stored respectively in registers 10C and 10D which store L0 and R0 of the value before starting the round operation, or the verification pattern stored in an internal memory 10A be set to the registers, and the circuit is configured so that a comparator 10H compares the value of registers 10E and 10F for storing L16 and R16 of the value after finishing all the round operations with an expected value stored in an internal memory 10G. By this configuration, in the decision processing period for deciding whether a fault exists or not, the verification pattern stored in the internal memory 10A is set to the registers 10C and 10D which store L0 and R0 of the value before starting the round operations by using the selectors 10B, and after the setting, as similar to the case of the round operations to a plain text, the round operations are performed for the verification pattern. After all the round operations are completed, values stored in the registers 10E and 10F are compared with the expected value stored beforehand in the internal memory 10G by the comparator 10H. When the degenerate faults exist in the registers that store the values after the round operations and in the combination circuit that performs the round operations, the values stored in the registers 10E and 10F may differ from the expected value by the influence of those faults. Accordingly, by connecting the output of the comparator 10H to the secret key invalidation circuit 1B, the secret key invalidation signal can be outputted. In this method, the data prepared beforehand for the fault detection can also be used as a partial key Ki used when performing the round operations, instead of the partial key generated from the secret key 4A.

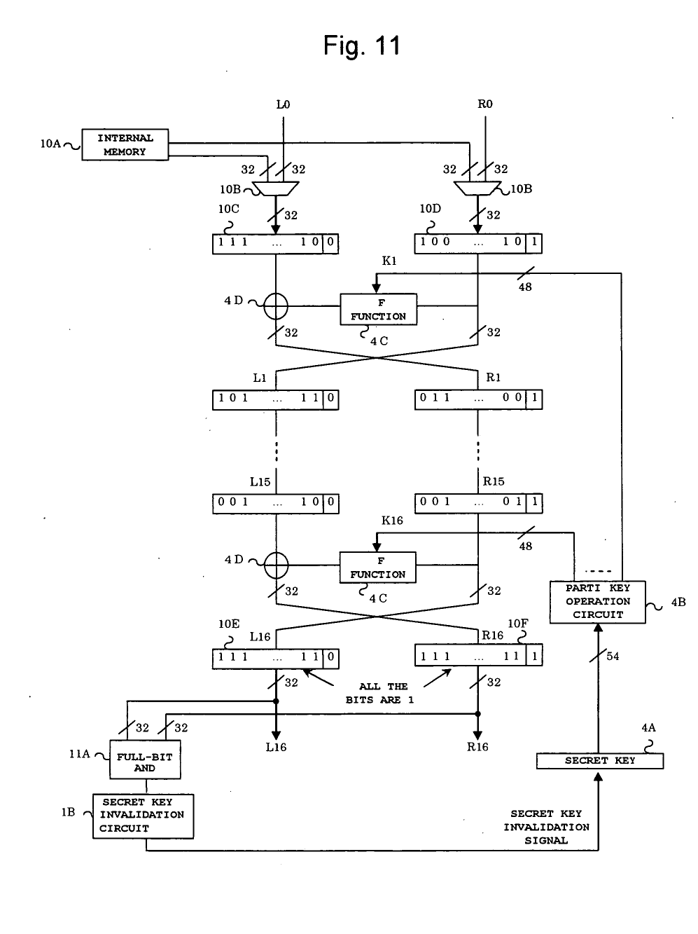

Also in this method, as shown in FIG. 11, by preparing the verification pattern by which all bits of the value of the data after finishing all the round operations become one, without storing the expected value in the internal memory 10G as shown in FIG. 10, the degenerate fault can be detected by using a full-bit AND 11A for the value after finishing all the round operation. In this case, although when a degenerate fault does not exist in the registers and the combination circuit all the values of the register 10E and the register 10F become one, when a fault exists, a bit of which value becomes one or zero will appear in a bit of either the register 10E or the register 10F.

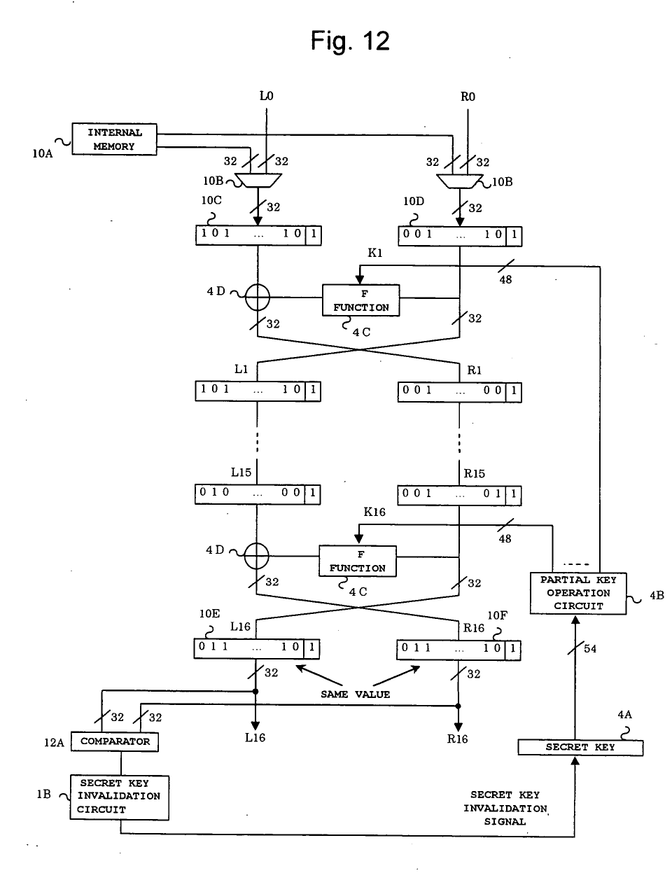

Further, as shown in FIG. 12, by preparing the verification pattern by which the values of the registers 10E and 10F which store the data after finishing all the round operations become equal to each other, without storing the expected value in the internal memory 10G as shown in FIG. 10, any degenerated fault can be detected by comparing values of the register 10E and the register 10F after finishing all the round operations by using a comparator 12A.

In the circuit in FIGS. 10, 11, and 12, instead of outputting the secret key invalidation signal from the secret key invalidation circuit 1B for invalidating the secret key 4A, the encryption circuit stop signal may be outputted from the secret key invalidation circuit 1B, allowing information that the fault exists to be informed to the circuit that controls the operation of the encryption circuit when the fault exists, so that the leakage of the secret key information can be prevented by stopping the processing of the encryption circuit.

As described above, by preparing the pattern for the fault detection beforehand, and by applying the round operations to this pattern, in addition to the degenerate fault which exists in the registers which store the values after the round operations, the degenerate fault in the combination circuit that performs the round operations can also be detected.

### Embodiment 5

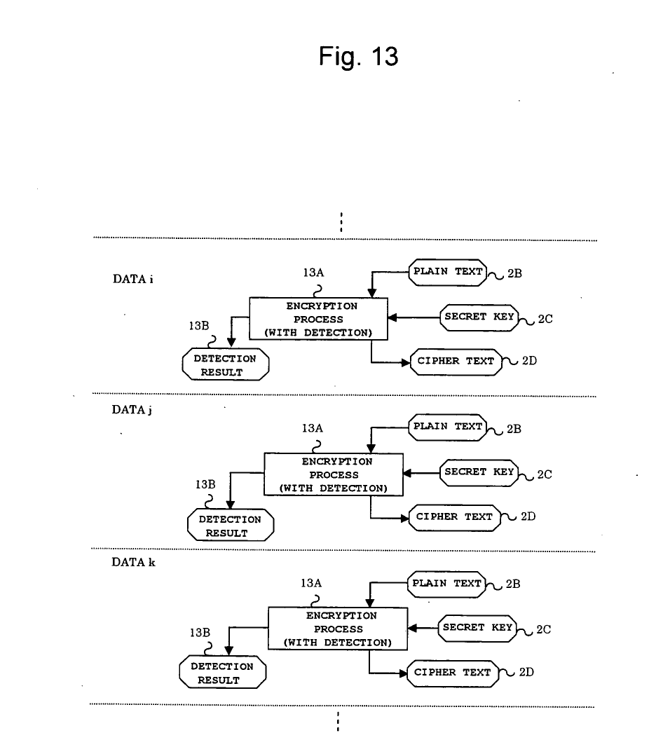

FIG. 13 is a diagram each showing the performing period of the fault detection of the encryption circuit 2A in a fifth embodiment of the present invention. In any one of the first to the fourth embodiments of the present invention, the encryption circuit 2A that realizes the DES algorithm and that has the countermeasure to the fault analysis performs the fault detection, when an encryption process 13A that encrypts the plain text 2B by using the secret key 2C is performed to obtain the cipher text 2D, as shown in FIG. 13, by setting the decision processing period for deciding whether the fault exists or not for the encryption processes 13A applied to all of the plain text 2B. A detection result 13B is outputted for each detection, and the secret key is invalidated or the processing of the encryption circuit is stopped when it becomes clear that the fault exists. By performing fault detection during the encryption processes for all the data as shown in FIG. 13, the leakage of the secret key can be prevented since the probability for detecting the fault can be increased.

### Embodiment 6

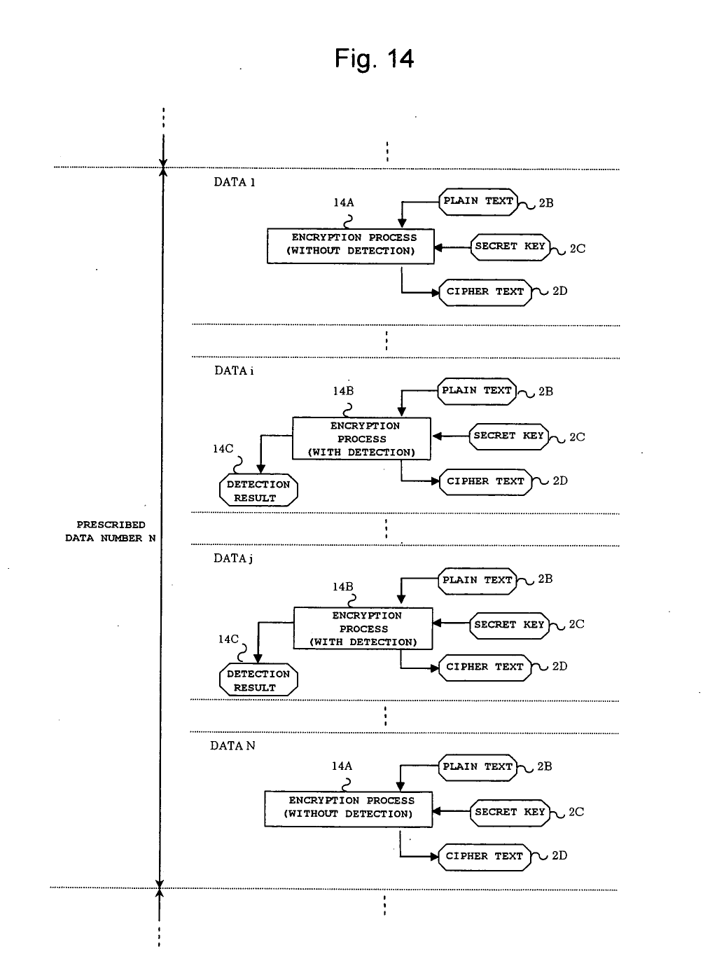

FIG. 14 is a diagram showing the performing period of the fault detection of the encryption circuit 2A in a sixth embodiment of the present invention. In any one of the first to the fourth embodiments of the present invention, the encryption circuit 2A that realizes the DES algorithm and that has the countermeasure to the fault analysis performs the fault detection, when the encryption processing by which the plain text 2B is encrypted by using the secret key 2C to obtain the cipher text 2D, by defining a prescribed data number N beforehand, and by setting the decision processing period for deciding whether the fault exists or not during the encryption processes for M data among N consecutive data (M<N). The number M of data to be decided can be set to an arbitrary value within the range of M<N. When M is set to 2 among N consecutive data, as an example, an encryption process 14B with the fault detection is applied to the i-th and the j-th data, as shown in FIG. 14, and an encryption process 14A without the fault detection is applied to the other data. Here, i and j can be set to arbitrary values as far as i is not equal to j, i is equal to or larger than 1 and is equal to or smaller than N, and j is equal to or larger than 1 and is equal to or smaller than N. The same can be said for the M value other than 2. In addition, the arbitrary number N can be set to any prescribed number. A detection result 14C is outputted from the encryption process 14B with the fault detection, and the secret key is invalidated or the processing of the encryption circuit is stopped when it becomes clear that the fault exists. Thus, by setting the prescribed number N, and by performing the fault detection during the encryption processes for M data among N consecutive data, the leakage of the secret key can be prevented while suppressing the required time for the fault detection, as compared with performing the fault detection during the encryption processes for all the data.

### Embodiment 7

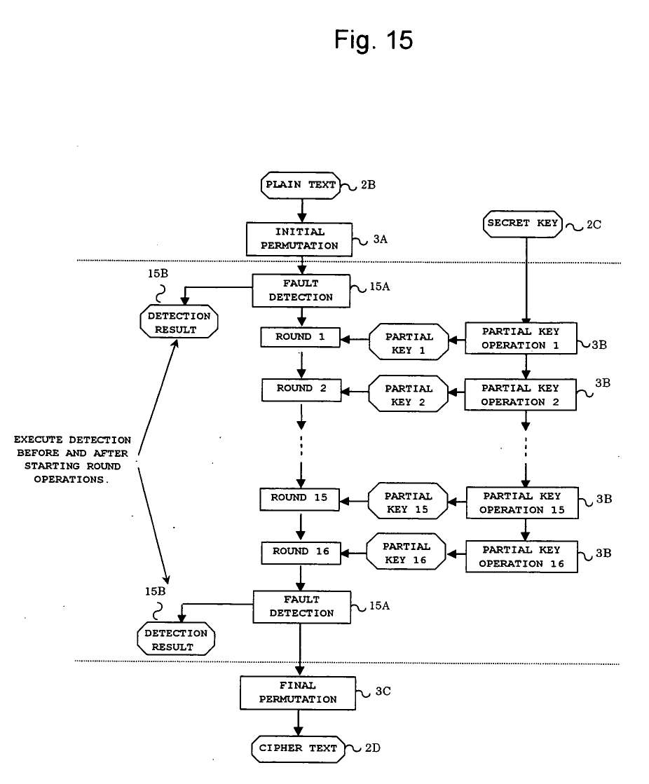

FIG. 15 is a diagram showing the performing period of the fault detection of the encryption circuit 2A in a seventh embodiment of the present invention. In any one of the first to the third embodiments, and the fifth and the sixth embodiments of the present invention, the encryption circuit 2A that realizes the DES algorithm and that has the countermeasure to the fault analysis performs the fault detection 15A, when the cipher text 2D is generated from the plain text 2B by using the secret key 2C, by setting the decision processing period for deciding whether the fault exists or not before starting R times of the round operations specified by the encryption processing standard and after finishing all of the round operations. A decision result 15B is outputted for each fault detection 15A, so that the secret key is invalidated or the processing of the encryption circuit is stopped when it becomes clear that the fault exists. The fault detection 15A can be performed only before starting the round operations, or only after finishing the round operations. Thus, by performing the fault detection only before or after the execution of the round operations, the leakage of the secret key can be prevented while reducing the required time for the fault detection.

### Embodiment 8

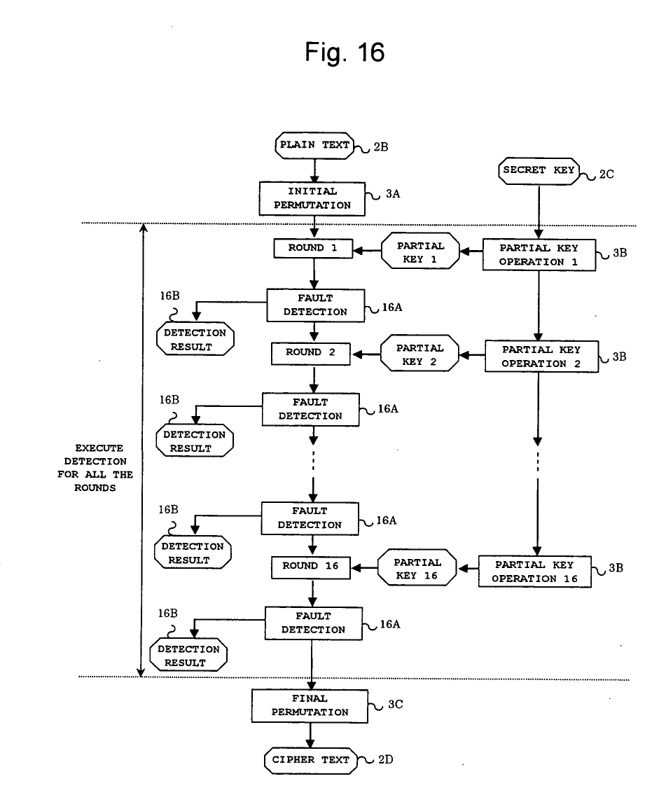

FIG. 16 is a diagram showing the performing period of the fault detection of the encryption circuit 2A in an eighth embodiment of the present invention. In any one of the first to the third embodiments, and the fifth and the sixth embodiments of the present invention, the encryption circuit 2A that realizes the DES algorithm and that has the countermeasure to the fault analysis performs a fault detection 16A, when the cipher text 2D is generated from the plain text 2B by using the secret key 2C, by setting the decision processing period for deciding whether the fault exists or not for all the R times of the round operations specified by the encryption processing standard. A decision result 16B is outputted for each fault detection 16A, so that the secret key is invalidated or the processing of the encryption circuit is stopped when it becomes clear that the fault exists. Thus, by performing the fault detection 16A in all of the round operations, the leakage of the secret key can be prevented since the probability for detecting the fault can be increased.

### Embodiment 9

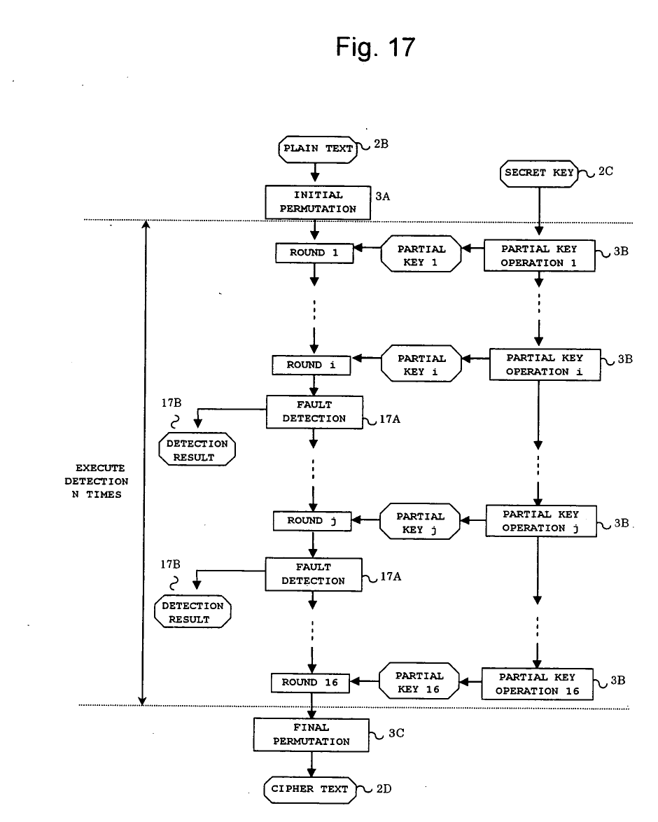

FIG. 17 is a diagram showing the performing period of the fault detection of the encryption circuit 2A in a ninth embodiment of the present invention. In any one of the first to the third embodiments, and the fifth and the sixth embodiments of the present invention, the encryption circuit 2A that realizes the DES algorithm and that has the countermeasure to the fault analysis performs a fault detection 17A, by setting a prescribed round number N, when the cipher text 2D is generated from the plain text 2B by using the secret key 2C, and by setting the decision processing period for deciding whether the fault exists or not for N times of the round operations among 16 times of the round operations. A decision result 17B is outputted for each fault detection 17A, so that the secret key is invalidated or the processing of the encryption circuit is stopped when it becomes clear that the fault exists. Here, execution times N of the fault detection can be set to an arbitrary number, and at which round operation the N times of the fault detection be executed can arbitrarily be chosen. Thus, by performing the fault detection 17A for the specified N times of the round operations, whether suppressing the time for the fault detection or increasing the probability of the fault detection can be selected while preventing the leakage of the secret key.

### Embodiment 10

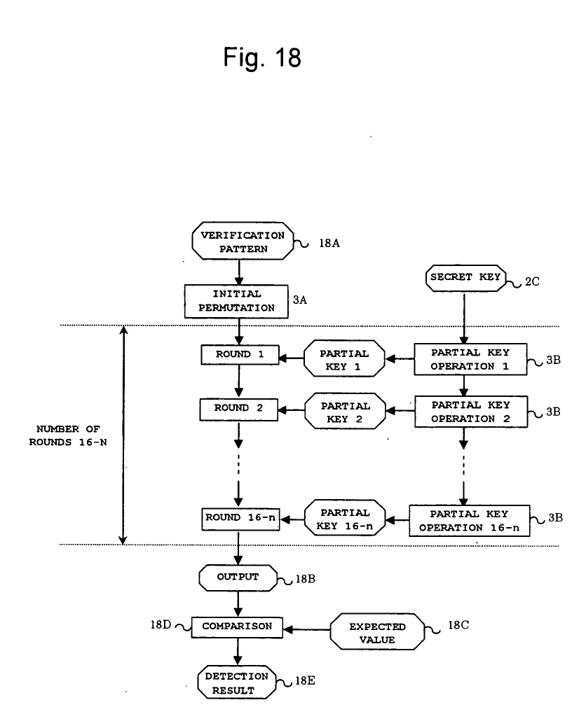

FIG. 18 is a diagram showing the performing period of the fault detection of the encryption circuit 2A in a tenth embodiment of the present invention. In any one of the fourth to the sixth embodiments of the present invention, the encryption circuit 2A that realizes the DES algorithm and that has the countermeasure to the fault analysis executes 16−n times (here, n is equal to or larger than 1 and equal to or smaller than 15) of the round operations of which number is n times fewer than the DES algorithm specification number of 16, in the decision processing period for deciding whether the fault exists or not, by applying the secret key 2C to a verification pattern 18A that is used for deciding whether the fault exists or not. After finishing 16−n times of the round operations, the obtained output 18B is compared with an expected value 18C which is prepared in advance by using a comparator 18D, to obtain a detection result 18E. According to the detection result 18E, the secret key is invalidated or the processing of the encryption circuit is stopped when it becomes clear that the fault exists. Thus, in the fault detection, the time required for the fault detection can be suppressed by executing the round operations n times fewer than the number of rounds specified by the DES algorithm.

### Embodiment 11

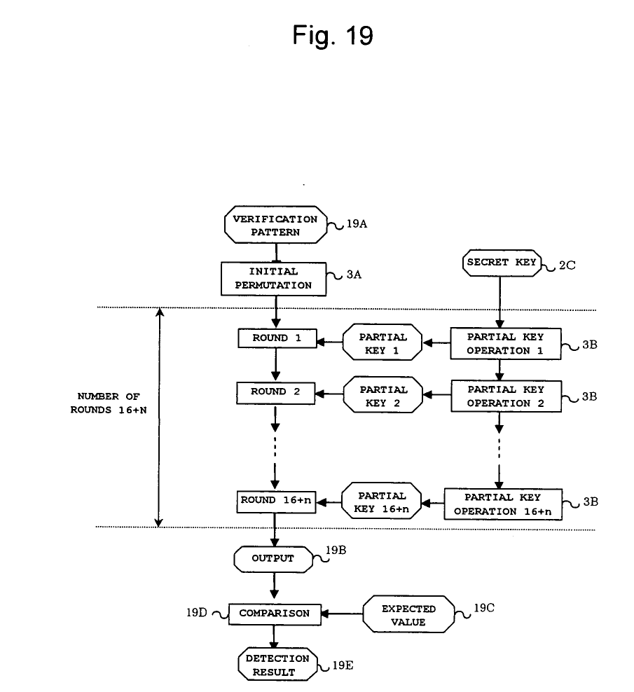

FIG. 19 is a diagram showing the performing period of the fault detection of the encryption circuit 2A in an eleventh embodiment of the present invention. In any one of the fourth to the sixth embodiments of the present invention, the encryption circuit 2A that realizes the DES algorithm and that has the countermeasure to the fault analysis executes (16+n) times (here, n is equal to or larger than 1) of the round operation of which number is n times larger than the DES algorithm specification number of 16 in the decision processing period for deciding whether the fault exists or not, by applying the secret key 2C to a verification pattern 19A that is used for deciding whether the fault exists or not. After finishing 16+n times of the round operations, an obtained output 19B is compared with an expected value 19C which is prepared in advance by using a comparator 19D, to obtain a detection result 19E. According to the detection result 19E, the secret key is invalidated or the processing of the encryption circuit is stopped when it becomes clear that the fault exists. Thus, in the fault detection, by executing the round operations n times larger than the number of the rounds specified by the DES algorithm, the probability of detecting the fault can be increased.

The present invention is effective for realizing a confidential information processing apparatus since the countermeasure to the fault analysis is included within its circuit. This circuit provides a benefit that an appropriate response can be available even when a new element of causing occurrence of the fault other than the voltage or heat is used, as compared with such a method of installing the circuit which detects heat or the voltage causing occurrence of a fault, and the benefit that the hardware cost is suppressed, or increase in the processing time is suppressed, by using the values of the registers that store the values after the round operations, as compared with the case where two-encryption circuits are used. Thus, this circuit is useful as the encryption circuit having the countermeasure to the fault analysis.

1. An encryption circuit of a secret key cryptosystem which inputs an object of encryption and a secret key, obtains R partial keys by applying R times of partial key operations to said secret key, and inputs said R partial keys for applying R times of round operations to said object of encryption so that said object of encryption is encrypted comprising:
registers which store values after said round operations for said object of encryption; a fault detection circuit which decides whether a degenerate fault exists or not by the values of the registers; and a circuit which inputs a detection result of said fault detection circuit and invalidates said secret key when said degenerate fault exists in said detection result.

2. An encryption circuit of a secret key cryptosystem which inputs an object of encryption and a secret key, obtains R partial keys by applying R times of partial key operations to said secret key, and inputs said R partial keys for applying R times of round operations to said object of encryption so that said object of encryption is encrypted comprising:
registers which store values after said round operations for said object of encryption; a fault detection circuit which decides whether a degenerate fault exists or not by the values of the registers; and a circuit which inputs the detection result of said fault detection circuit and which stops operation of said encryption circuit by a circuit which controls operation of said encryption circuit, when said degenerate fault exists in said detection result.

3. The encryption circuit according to claim 1 wherein the fault detection circuit decides whether the degenerate fault exists or not in the registers that store values after the round operations, by the values before and after storing in said registers.

4. The encryption circuit according to claim 1 wherein the fault detection circuit decides whether the fault exists or not by the values of the registers after finishing the round operations performed for a verification pattern which is prepared beforehand.

5. The encryption circuit according to claim 1 wherein the fault detection circuit decides whether the fault exists or not for encryption processes for all the data.

6. The encryption circuit according to claim 1 wherein the fault detection circuit decides whether the fault exists or not for M data (M<N), during the encryption processes for consecutive N data.

7. The encryption circuit according to claim 1 wherein the fault detection circuit decides whether the fault exists or not before starting R times of the round operations and after finishing R times of the round operations.

8. The encryption circuit according to claim 1 wherein the fault detection circuit decides whether the fault exists or not for all R times of the round operations.

9. The encryption circuit according to claim 1 wherein the fault detection circuit decides whether the fault exists or not for N times (N<R) of the round operations among R times of the round operations.

10. The encryption circuit according to claim 4 wherein the fault detection circuit performs the round operations for the verification pattern for R−n times of the round operations which are n times fewer than the R times of the round operation number specified by an encryption processing standard, and decides whether the fault exists or not by an obtained value.

11. The encryption circuit according to claim 4 wherein the fault detection circuit performs the round operations for the verification pattern for R+n times of the round operations which are n times larger than the R times of the round operation number specified by the encryption processing standard, and decides whether the fault exists or not by the obtained value.

12. The encryption circuit according to claim 2 wherein the fault detection circuit decides whether the degenerate fault exists or not in the registers that store values after the round operations, by the values before and after storing in said registers.

13. The encryption circuit according to claim 2 wherein the fault detection circuit decides whether the fault exists or not by the values of the registers after finishing the round operations performed for a verification pattern which is prepared beforehand.

14. The encryption circuit according to claim 2 wherein the fault detection circuit decides whether the fault exists or not for encryption processes for all the data.

15. The encryption circuit according to claim 2 wherein the fault detection circuit decides whether the fault exists or not for M data (M<N), during the encryption processes for consecutive N data.

16. The encryption circuit according to claim 2 wherein the fault detection circuit decides whether the fault exists or not before starting R times of the round operations and after finishing R times of the round operations.

17. The encryption circuit according to claim 2 wherein the fault detection circuit decides whether the fault exists or not for all R times of the round operations.

18. The encryption circuit according to claim 2 wherein the fault detection circuit decides whether the fault exists or not for N times (N<R) of the round operations among R times of the round operations.

19. The encryption circuit according to claim 13 wherein the fault detection circuit performs the round operations for the verification pattern for R−n times of the round operations which are n times fewer than the R times of the round operation number specified by an encryption processing standard, and decides whether the fault exists or not by an obtained value.

20. The encryption circuit according to claim 13 wherein the fault detection circuit performs the round operations for the verification pattern for R+n times of the round operations which are n times larger than the R times of the round operation number specified by the encryption processing standard, and decides whether the fault exists or not by the obtained value.
